(19) United States
(12) Patent Application Publication
(10) Pub. No.: US 2011/0053556 A1
(43) Pub. Date: Mar. 3, 2011

(54) Computer Mouse For Secure Communication With A Mobile Communication Device

(75) Inventors: Michal Masaryk, Bratislava (SK); Michal Vidurek, Vracov (CZ)

(73) Assignee: LOGOMOTION, S.R.O., Piestany (SK)

(21) Appl. No.: 12/864,617

(22) PCT Filed: Feb. 26, 2010
(86) PCT No.: PCT/IB10/50846

§ 371 Date: Jul. 26, 2010

(30) Foreign Application Priority Data
Feb. 27, 2009 (SK) PP50009-2009

(51) Int. Cl. H04M 11/00; G09G 5/08; H04B 5/00

(52) U.S. Cl. 455/406; 345/163; 455/41.1

(57) ABSTRACT

As disclosed herein, a computer mouse (1) may include a contact-less communication element (2) for communication with a mobile communication device (3), such as a mobile phone. The communication element (2) may be a near-field communication (NFC) element, and may be adapted to establish a connection with a secure element (4) for processing data communicated between a computer (5) and the mobile communication device (3). The secure element (4) may be configured in a memory device, which may be located in the computer mouse (1) or on a separate carrier (6). The carrier (6) may be a removable memory card, the insertion of which into a corresponding connector (7) may establish a connection between the communication element (2) and the secure element (4). The communication element (2) may include an antenna, which may be formed on a printed circuit board in the computer mouse (1). A computer mouse (1) as described herein may enable a computer (5) to communicate with a mobile communication device (3) in a secure manner.

### TECHNOLOGY

Described herein is a computer mouse that enables electronic data transmission during, for example, cashless payments. The computer mouse may establish a secure communication channel between a mobile communication device, such as a mobile phone, for example, and a computer. The secure communication channel may enable management and/or confirmation of a payment realized via the mobile communication device. Also described are systems and methods for data transmission during electronic payments.

### PRESENT TECHNOLOGY

Mobile phones are used as means of payment in cashless payments. The contact-less communication connection with the payment terminal is created through a short-reach radiofrequency connection, often in the near-field communication (NFC) format. With the increasing interest in internet shopping, it will be necessary to create payment terminals even from the personal computers of respective users, a situation, which, of course, requires creation of a sufficiently secure communication channel between the mobile phone, personal computer and payment processing headquarters. Separate NFC readers that can be connected to a personal computer already exist; however these do not have sufficient security level for processing of payment information and they are also quite complicated from the user's point of view.

A computer mouse is a well-known peripheral device for computers. EP 1752902A2 describes a computer mouse with a secure memory, an encryption processor for de-blocking of the memory and it can also contain a biometric identifier, a biometric sensor. This computer mouse is defined so it can transfer data in a secure manner, but it cannot communicate with a mobile phone. There also exist some tendencies to extend the computer mouse functions as in the patent JP 2003131808, where a mouse has an optical sensor for input of product's price data. There also exists a computer mouse as in DE10130019A1 that comprises a card reader with a keyboard for data entering; however this one is not adapted for a communication with a mobile phone. Similarly, the computer mouse as in EP1943606A2 enables a user to enter personal data, such as PIN codes, into the computer. The computer mouse as in KR20020073106 contains a chip card reader and a contact-less connection to a computer; however it is not capable of communication with a mobile phone.

Devices and systems that are known so far do not create a secure communication channel between a mobile phone and a computer (in the function of a point of sale (POS) terminal in a form that would require only a simple addition to existing computer units. A solution that could add functionalities to a common computer unit without the need for hardware changes within the computer itself is desirable. However at this time, there is no solution known that would enable a user to enter authorization confirmation using a mobile phone via a computer mouse while paying via internet banking. With internet banking are used separate, mainly one-purpose devices (such as token, calculators, card readers for example) which makes the use of the electronic payment more complicated.

### DESCRIPTION OF EXAMPLE EMBODIMENTS OF THE INVENTION

The deficiencies mentioned are to a large extent eliminated by a computer mouse that may be used to transmit data between a mobile communication device and a computer during electronic payments that are realized using a mobile communication device, such as a wireless phone or FOB, for example. The computer mouse may include a data transmission block and may be adapted to be connected to the computer as described herein. The computer mouse may be equipped with a contact-less communication element for communication with the mobile communication device. The contact-less communication element may be located permanently in the body of the computer mouse or in a removable carrier that may be connected to the computer mouse during data transmission. Thus, the computer mouse may provide a communication channel to the mobile communication device. As the contact-less communication element may enable short distance data transmission; the mobile communication element may be placed in relative proximity (e.g., 0 to 15 cm) to the computer mouse.

The communication element may be adapted to establish a connection with a secure element for processing data communicated between the computer and the mobile communication device. Thus, the computer unit may communicate with the mobile communication device via the computer mouse, while other, typical functionalities of the computer mouse are not affected.

Secure element is a protected part of a memory which in a safe way, processes data mainly by the means of encrypting and decrypting of files. In this part of memory, private keys and sensitive data are stored. Further requirements and standards concerning secure elements are listed in regulations. Communication circuit may be electronic circuit for radio transmission and receiving of signals and may also contain elements for a basic processing of data. The communication element is connected to an antenna which ensures receiving and/or transmitting of signals in the set frequency.

The position of the secure element in a computer mouse or in an electronic device connected to the mouse enables, with the appropriate software equipment, to provide security for transmitted sensitive payment data into a computer already in the transmission phase.

The communication element may be radio-frequency communication element, such as a near-field communication (NFC) element, for example. Some common types of mobile phones are equipped with such a communication element or they can be further equipped with it through a removable card. Thus, the mobile communication device may have an NFC element that communicates with the NFC element in the computer mouse.

The communication element's antenna maybe formed directly on a printed circuit board in the computer mouse, e.g., in the form of a conduction path of a necessary shape and proportion.

The connection between the communication element in the computer mouse and the secure element may be used for processing data transferred between the computer and the mobile communication device. This connection may be a permanent connection, where the secure element is configured in a memory that is located in the computer mouse.

The secure element may be used for encryption of transferred data, and may be a part of the computer mouse itself or of an external element that is connected to the computer mouse while data is being transferred. For example, the secure element can be in a secured part of a memory device that is located on a printed circuit board in the computer mouse. In another example, a connector may be located on an external surface of the computer mouse. A separate carrier with the secure element may be seated into the connector before the data transfer process is started. In this configuration, it may be acceptable for the communication element's antenna to be activated only after the separate carrier is connected to the computer mouse. In this configuration, the security element may be located in the separate carrier, which may be adapted to be received into the connector. The connector may be located in the computer mouse, which may have a corresponding slot for the carrier on it's external surface and which may be connected with the data processing unit and with the communication element.

The carrier can be equipped with a communication element with an antenna. In such a configuration, the carrier may be connected functionally to the computer mouse, even if it is separate from the computer mouse itself. In case two communication elements are used, or in case one communication element and two antennas are used, the antenna within the body of the computer mouse may be used. Given its spatial possibilities, this antenna has better transmission characteristic and allows for the phone to be placed in a more accurate way next to the computer mouse's body.

In one of the possible variants the secure element may be located permanently in hardware of the mouse; usually it may be fixed on a printed circuit of the mouse. In such configuration is the secure element connected on a printed circuit to the processing unit and the communication device. In this configuration, the communication device will have the antenna directly in the mouse where is enough space for its efficient creation for example in a form of conductive path on the printed circuit.

In other configuration the secure element may be separable from the hardware of the mouse while at transmission the carrier will be connected to the secure element with the mouse hardware. In a variant with separable secure element the carrier with the secure element may have a various form; it may be a one-purpose element with the particular connector or the carrier may be in a form of a memory card for instance SD card or it may be USB key whereas this carrier will be equipped with a connector for a connection to the particular boundary in the mouse hardware.

Configuration with separable secure element may have, regardless of the form of the carrier, many variants. In one variant has the carrier the secure element with a particular power hardware and software, in other variant the secure element may also have a communication element. This communication element may be connected to the antenna located directly on a carrier—for example on SD card or USB FOB. In this variant the mouse will after inserting the carrier into the mouse, contain two antennas, two communication elements. Created may be other variants of placement of particular elements between the mouse and separable part of the mouse or all the described elements may be located in the mouse permanently without the possibility of separation by the user.

Significant is such connection of the secure element with data processing unit, communication device and with antenna which will make from a computer mouse a safe boundary for communication with a mobile phone. On the side of a mobile phone may be used as a communication element a removable card equipped with an antenna, transmitting—receiving unit and a particular boundary for the connection with the mobile phone.

The computer mouse may be equipped with a reader of an electronic register's fiscal module which is a hardware core of electronic cash registers required according to some national laws to issue bills for the received cash payments.

The fiscal module is inserted into the body of the computer mouse. The core of the fiscal module must, in accordance with law, meet the requirements for accounting and keeping of the fiscal data. Until now the core was included in a separate, one-purpose device—in an electronic cash register. In this suggested solution a computer mouse may include also a fiscal module. Then a computer with a printer is able to fulfill due to this mouse, the function of an electronic cash register.

The separate carrier can be a removable memory card of a common, standardized format and the connection connector may be that of a card reader. Another possibility would be to have a connection connector of the USB type, in which the carrier could be an USB memory key or otherwise include a memory and USB connector. The part of the memory containing the secure element could be adjusted so personal or other data of the user could be stored in it.

A computer mouse having a communication element and secure element as described above is not just an unusual technical combination that enhances the functionality of the computer mouse, but it also presents a user friendly technical solution of the communication channel between the mobile communication device and the computer. During data transfer, a short reach technology, e.g., of the NFC type, may be used in the mobile communication device so it may be necessary to tap the mobile communication device directly to the particular communication element of the reader. For that reason, the computer mouse is a suitable carrier, as it may easily be placed within the user's reach. Thus, a solution is provided in which it is not necessary to use a separate computer peripheral device, such as an NFC reader or individual computer mouse, which, besides other things, would increase the utilization of the computer's available USB connectors.

From the point of view of easy installation, it is suitable, if the computer mouse as described herein, along with a SIM card as typically used in a mobile communication device and preferably even with a memory card and software formed a computer update set for secure data transmission. The update set does not require hardware changes of the computer, insertion of a card into a slot or similar, while still offering required security of transmitted data.

The deficiencies mentioned in the current state of the art are to a large extent eliminated by the data transmission method used between the mobile communication device, such as a mobile phone and the computer while realizing electronic payment through a mobile communication device. To process data, the mobile communication device is using the secure element described in this invention. The communication element transfers data between a computer mouse and a mobile communication device. The data transfer between the computer mouse and the computer is realized through a communication link that was originally created, to transmit location data from the computer mouse—the information about location, i.e. information about the computer mouse movement, i.e. the mouse wheel movement. So a common transmission channel of a computer mouse is used for transmission process between the mobile communication device and a computer.

The usage of a computer mouse in transmission string is not traditional from the technical point of view and thanks to the connection with secure element or directly thanks to the placement of the secure element into the computer mouse, the encryption of the transmitted data is reached in such way so they enter the computer on a required security level.

During transmission, the data are processed in the secure element, which is placed in the computer mouse or which is connected to the computer mouse during transmission. The processing of the data within the secure element is based on the encryption and decryption of data.

The data transmission method using a computer mouse as described above enables a secure data transmission in payment processes. In such a payment process, the POS terminal may be created in a virtual form within the computer, FOB, or some mobile communication device and it also enables transfer of authorization data while using internet banking.

An example use of a computer mouse as described herein will be a configuration for the transmission of data between the mobile phone and the computer during electronic payments. The mobile phone may have a removable memory card with a contact-less communication element and an antenna. The computer mouse may be connected to the computer. The hardware of the computer mouse may be supplemented with an antenna and a connector for connection with the carrier. The carrier may have a secure element and a communication element with its own antenna.

### BRIEF DESCRIPTION OF THE DRAWINGS

An example embodiment of the invention is described in more detail in connection with FIGS. 1-6.

FIG. 1 depicts a computer mouse that contains a memory with a secure element.

FIG. 2 depicts a computer mouse with an SD memory card reader, with a secure element.

FIG. 3 depicts a computer mouse with a connected USB memory key having a secure element.

FIG. 4 depicts a configuration of a computer mouse with a connected carrier, which is equipped with a communication element with an antenna.

FIG. 5 depicts a computer mouse with a removable cover of an opening into which a carrier with a communication element and an antenna are inserted.

FIG. 6 depicts a block diagram of a payment application in a process controlled via GUI from a mobile phone communicating with a computer mouse. This figure shows an example of dividing tasks at order of payment processing when coming from a computer into the clearing area of a bank are data in a commonly used format for a communication with POS terminal.

### REALIZATION EXAMPLES

### Example 1

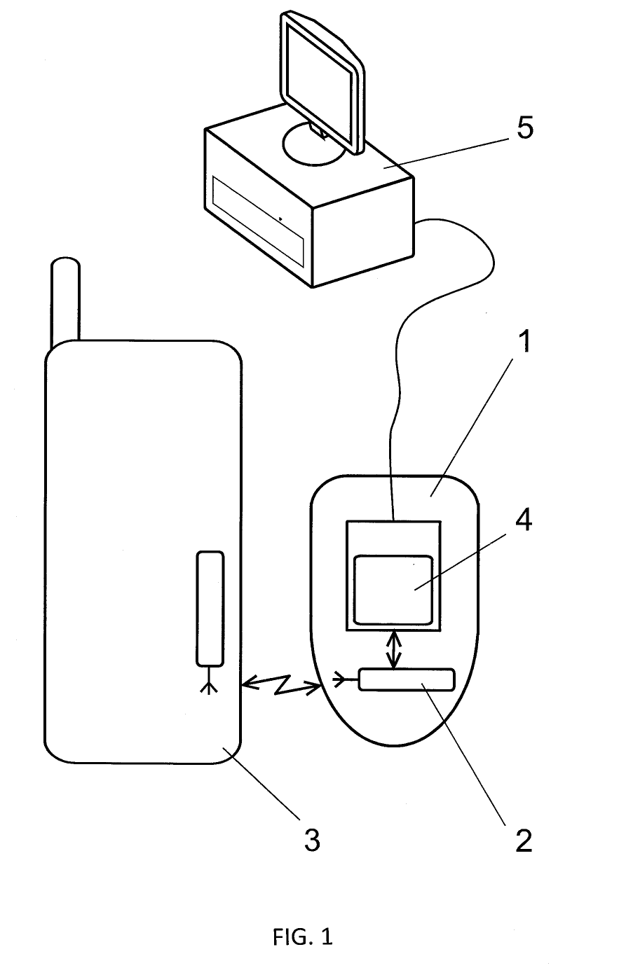

As depicted in FIG. 1, a computer mouse 1 may be an optical computer mouse 1 and may include standard key and wheel functions. The computer mouse 1 may have a contact-less, near-field communication (NFC) element 2 for communication with a mobile communication device 3, which may be a mobile phone with a NFC chip. The communication element 2 in the computer mouse may be connected with a secure element 4. The secure element 4 may be a secured part of a memory device, which may be located directly on the printed circuit board of the computer mouse 1. In the secure element 4, data sent between the mobile communication device 3 and the computer 5 may be processed, encoded, and decoded The secure element 4 may be connected with the data processing unit 8 and the processing unit 8 may be connected to an output of the computer mouse 1 that is connected to the computer 5. The computer mouse 1 may be connected to the computer 5 by a cable and an USB connector, for example. The communication element 2 may have an antenna that is designed as a conductive path that is placed directly on the printed circuit board of the computer mouse 1, which makes the production of the device easier.

Basically, the computer mouse 1 may assume the role of an NFC reader, since it provides a secure communication path between the mobile phone and the computer 5. Using a mouse as described herein, the computer 5 will be capable of secure communication with the NFC chip of the mobile phone.

### Example 2

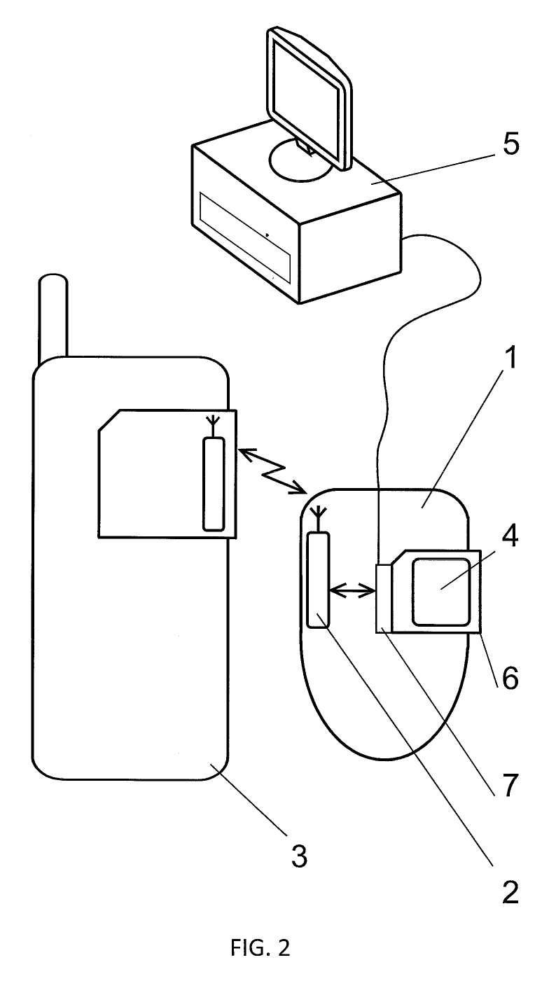

The computer mouse 1 depicted in FIG. 2 includes a contact-less radiofrequency communication element 2 designed for communication with the mobile communication device 3. On the side of the mobile communication device 3, there may be a contact-less radiofrequency connection function with short reach, that is ensured by an additionally inserted removable card, that contains an antenna and the transmitting and receiving element. Within the computer 5 update set, as described in this example, there is an additional removable card with corresponding software which will add functionalities to the mobile communication device 3. The computer mouse 1 also contains an SD card or microSD card reader. The communication element 2 is connected to the SD card or microSD card reader. The memory SD card in the function of a separate carrier 6 is adjusted for the cooperation with computer mouse 1 and has a reserved, secured part of the memory, that forms a secure element 4. A connection between the communication element 2 and the secure element 4 is created by inserting the memory card into the connection connector 7. This connection activates the communication element 2, which subsequently expects signals with the data from the mobile communication device 3 on a corresponding frequency.

A mobile communication device 3 with an activated authorization process may be tapped to the computer mouse 1. The data that are transferred into the computer mouse 1 are processed in the secure element 4 on the SD card. The processing of data in the secure element 4 is based on the encoding and decoding of data. Subsequently the data are sent to the computer 5 over the cable that connects the computer mouse 1 with the computer 5.

### Example 3

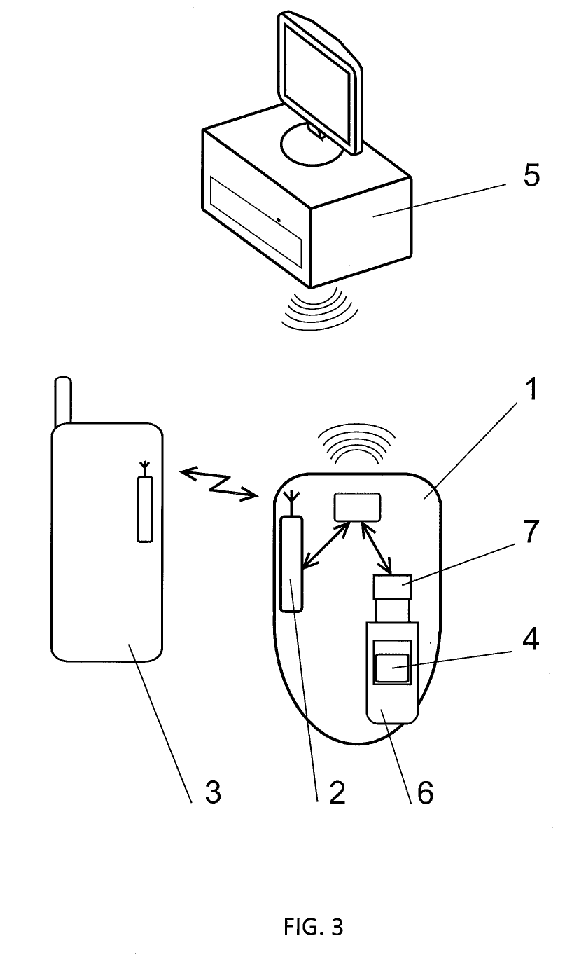

As shown in FIG. 3, the computer mouse 1 may be connected to the computer 5 in a contact-less way. The computer mouse 1 may include an NFC communication element 2 for communication with the mobile communication element 3. A secure element 4 may be configured in a separate carrier 6 in the form of an USB memory key, for example. The key may be designed for a connection with the connecting connector 7, which may be on an external surface of the computer mouse 1.

The computer mouse 1 as described in this example may form part of a computer 5 update set. Within this set, there may also be a SIM card designed to be inserted into the mobile phone, the USB memory key, installation software for the computer mouse 1 and software supporting the transmission of the payment data. The contact-less connection between the computer mouse 1 and the computer 5, that was originally created to transmit the location data from the computer mouse 1 is used also for the transmission of data that are being processed and transmitted in connection with the payment process.

### Example 4

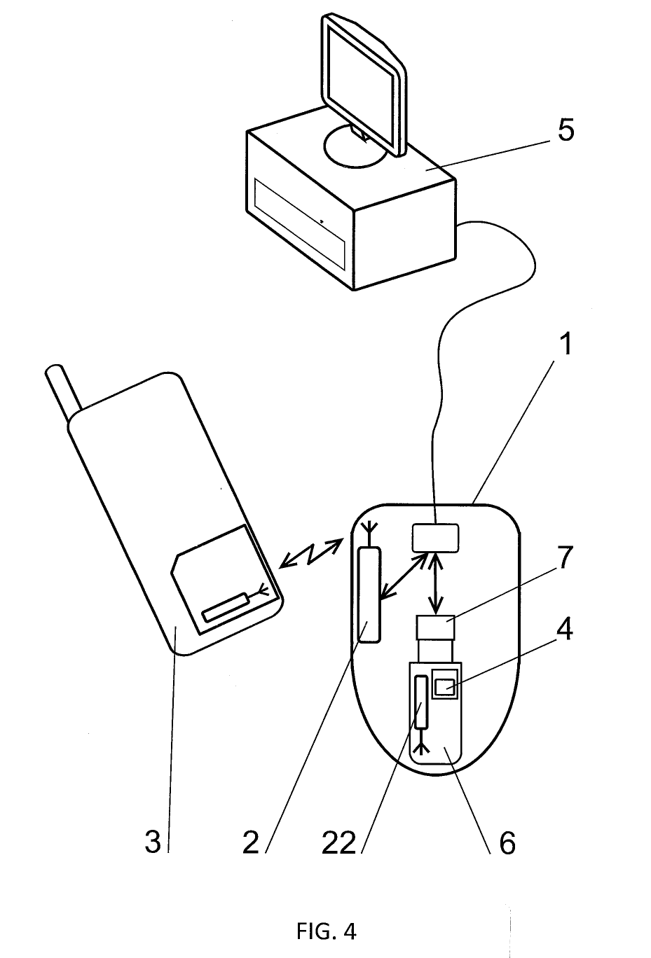

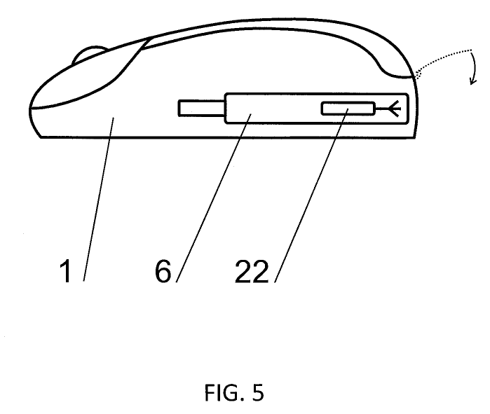

The computer mouse 1 depicted in FIGS. 4 and 5 is an optical computer mouse 1 with common functionalities and is connected to the computer 5 with a USB cable. The computer mouse 1 has an outside body with a removable cover, after opening of which there is an opening for the insertion of the carrier 6. The carrier may be equipped with a contact-less NFC communication element 22 for the communication with the mobile communication device 3, which may be a mobile phone with a NFC communication channel in removable card 9. The second communication element 2 may be located within the computer mouse 1, where it may be connected to a secure element 4. The carrier 6 may be capable of operating even outside the computer mouse 1 by virtue of its having its own communication element 22 with an antenna. After inserting the carrier 6 into the computer mouse 1 the transmission process may be realized via the communication element 2, which may be formed on a printed circuit board of the computer mouse. Given its larger spatial possibilities in the body of the computer mouse 1, this element has an antenna that could be designed in a more suitable and stronger antenna. In a different configuration there could be only one communication element 22 in the carrier 6, which is active during both, transmission when outside of the computer mouse 1 and transmission, when the carrier 6 is inserted into the computer mouse 1. The combined configuration with two communication elements 2, 22 enables use of the carrier 6 individually and when it is connected to the computer mouse 1. In this example the computer mouse 1 is also equipped with a reader of a fiscal module.

### INDUSTRIAL USABILITY

The industrial usability is obvious. According to this invention it is possible to produce, connect and use a computer mouse for data transfer, especially while realizing electronic payments through a mobile communication device.

### THE LIST OF RELATED SYMBOLS

1—a computer mouse
2—a communication element
22—a communication element in a carrier
3—a mobile communication device
4—a secure element
5—a computer
6—a carrier
7—a connection connector
8—a data processing element
9—a removable card in a phone

1-15. (canceled)

16. A computer mouse for transferring data between a mobile communication device and a computer, the computer mouse comprising:
a data processing element;
a secure element in connection with the data processing element; and
a contactless communication element that is adapted to communicate with the mobile communication device,
wherein the communication element is in connection with the secure element for processing data communicated between the computer and the mobile communication device.

17. The computer mouse of claim 16, wherein the contactless communication element is a near-field communication (NFC) element that corresponds to a corresponding NFC element in the mobile communication device.

18. The computer mouse of claim 16, further comprising a printed circuit board, wherein the contactless communication element comprises an antenna disposed on the printed circuit board.

19. The computer mouse of claim 16, further comprising a memory, wherein the secure element resides in the memory.

20. The computer mouse of claim 16, further comprising a slot for receiving a separate carrier, and a connector for mating with the separate carrier when the separate carrier is received into the slot, wherein the secure element resides on the separate carrier.

21. The computer mouse of claim 20, wherein the separate carrier is a removable memory card and the connector is part of a removable card reader.

22. The computer mouse of claim 20, wherein the separate carrier is a universal serial bus (USB) memory key, and the connector is in USB format.

23. The computer mouse of claim 20, wherein the separate carrier comprises a communication element.

24. The computer mouse of claim 20, wherein the computer mouse, along with a SIM card that is adapted to be inserted into the mobile phone, a USB memory key, installation software for the computer mouse, and software supporting transmission of payment data, form a computer update set for a secure transaction.

25. The computer mouse of claim 16, further comprising a fiscal module.

26. A method for transmitting data between a mobile communication device and a computer, the method comprising:
providing a computer mouse comprising a data processing element, a secure element in connection with the data processing element, and a contactless communication element that is adapted to communicate with a mobile communication device; and
transferring data between the mobile communication device and the computer via a transmission path through the computer mouse.

27. The method of claim 26, wherein transferring the data comprises processing the data in the secure element.

28. The method of claim 27, wherein processing the data in the secure element comprises encrypting or decrypting the data.

29. The method of claim 26, wherein the computer mouse comprises a slot for receiving a separate carrier, and a connector for mating with the separate carrier when the separate carrier is received into the slot, and wherein the secure element resides on the separate carrier, the method further comprising:
receiving the separate carrier into the slot;
connecting the carrier with the connector; and
activating the contactless communication element only after the carrier is connected with the connector.

30. A system for transferring data between a mobile communication device and a computer via a transmission path through a computer mouse, the system comprising:
a mobile communication device comprising a contactless communication element;
a computer; and
a computer mouse in communication with the computer;
wherein computer mouse comprises a data processing element, a secure element in connection with the data processing element, and a contactless communication element that is adapted to communicate with the contactless communication element of the mobile communication device.
